(19) United States
(12) Patent Application Publication
(10) Pub. No.: US 2004/0014588 A1
(43) Pub. Date: Jan. 22, 2004

(54) NPO DIELECTRIC COMPOSITIONS

(76) Inventors: Godefridus J.F.A. van Iersel, GM Best (NL); Michael Hausser, Frankfurt (DE); Ian Burn, Hockessin (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/199,958

(22) Filed: Jul. 19, 2002

(51) Int. Cl. C04B 35/465; C04B 35/468; C04B 35/47

(52) U.S. Cl. 501/136; 501/137

(57) ABSTRACT

The present invention provides a composition that can be sintered at a temperature of about 1025° C. or less to form an NPO dielectric ceramic. The composition according to the invention includes a mixture of from about 90% to about 99.5% by weight of a calcined (Ba, Ca, Sr, Nd, Gd)TiO₃ main component and from about 0.5% to about 10% by weight of an additive component. The additive component includes a glass including by weight from about 45% to about 54% BaO, from about 19% to about 24% ZnO, from about 13% to about 20% B₂O₃, and from about 2% to about 23% SiO₂.

### FIELD OF INVENTION

The present invention provides a composition for use in forming a sintered NPO dielectric ceramic. More particularly, the present invention provides a composition that can be sintered at a temperature of about 1025° C. or less to form an NPO dielectric ceramic.

### BACKGROUND OF THE INVENTION

NPO dielectric ceramics are used in a variety of electronic devices including, for example, co-fired multilayer ceramic capacitors (MLCC's). MLCC's typically comprise a stack of alternating internal metal electrode layers and dielectric ceramic layers. The internal electrode layers are typically formed from mixtures or alloys of silver and more expensive metals such as palladium, platinum, and gold. The minimum sintering temperature of the composition used to form the dielectric ceramic layers generally dictates the minimum palladium content of the internal electrode layers. Lower firing NPO dielectric compositions are desired because they allow for the formation of internal electrode layers using less palladium, platinum, and/or gold.

Furukawa et al., U.S. Pat. No. 6,174,831, disclose a dielectric ceramic composition for use in forming an NPO dielectric ceramic that can be sintered at a temperature of 1100° C. to 1150° C. The dielectric ceramic composition according to Furukawa et al. consists of a mixture of calcined (Ba, Ca, Sr, Nd, Gd)TiO₃ and from about 1% to about 5% by weight of an additive consisting of ZnSiTiO₅, ZnSi₂TiO₇, and/or CaSiTiO₅. Compositions are needed that can be sintered at lower temperatures to produce NPO dielectric ceramics.

### SUMMARY OF THE INVENTION

The present invention provides a composition that can be sintered at a temperature of about 1025° C. or less to form an NPO dielectric ceramic. The composition according to the invention comprises a mixture of from about 90% to about 99.5% by weight of a calcined main component comprising (Ba, Ca, Sr, Nd, Gd)TiO₃ and from about 0.5% to about 10% by weight of an additive component comprising a glass. The glass preferably comprises by weight from about 45% to about 54% BaO, from about 19% to about 24% ZnO, from about 13% to about 20% B₂O₃, and from about 2% to about 23% SiO₂. The composition according to the invention makes it possible to form co-fired MLCC's having internal metal electrodes containing as little as about 10% by weight palladium.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF PREFERRED EMBODIMENTS

The present invention provides a composition that can be sintered at a temperature of about 1025° C. or less to form an NPO dielectric ceramic. Throughout the instant specification and in the appended claims, the term “NPO dielectric ceramic” refers to a sintered ceramic dielectric material that meets the present EIA (Electronic Industries Association) specifications for NPO temperature coefficient of capacitance. According to present EIA specifications, the maximum allowable change in electrostatic capacity for an NPO dielectric ceramic is ±0.3% over a temperature range of −55° C. to +125° C.

A composition according to the present invention comprises a mixture of from about 90% to about 99.5% by weight of a calcined main component and from about 0.5% to about 10% by weight of an additive component. The calcined main component comprises (Ba, Ca, Sr, Nd, Gd)TiO₃ and preferably 0.5% to about 2.0% by weight of SiO₂ as a subsidiary component. Throughout the instant specification and in the appended claims, the term “(Ba, Ca, Sr, Nd, Gd)TiO₃” refers to a calcined material formed by calcining starting materials providing by weight from about 15% to about 19% BaO, from about 0.8% to about 1.7% CaO, from about 0.8% to about 1.3% SrO, from about 12% to about 27% Nd₂O₃, and from about 13% to about 29% Gd₂O₃, from about 38% to about 42% TiO₂, and optionally up to about 2% SiO₂. The starting materials used to form the (Ba, Ca, Sr, Nd, Gd)TiO₃ can be oxides or precursors to oxides such as carbonates (e.g., BaCO₃, CaCO₃, and SrCO₃). In the most preferred embodiment of the invention, the starting materials provide by weight about 17.46% BaO, about 1.38% CaO, about 1.02% SrO, about 23.94% Nd₂O₃, about 15.64% Gd₂O₃, about 39.39% TiO₂, and about 1.16% SiO₂.

The additive component comprises a glass. In the preferred embodiment of the invention, the glass comprises one or more glass frits comprising by weight from about 45% to about 54% BaO, from about 19% to about 24% ZnO, from about 13% to about 20% B₂O₃, and from about 2% to about 23% SiO₂. In the presently most preferred embodiment of the invention, the glass comprises by weight about 52.6% BaO, about 23.2% ZnO, about 17.9% B₂O₃, and about 6.3% SiO₂.

The main component is preferably formed by weighing appropriate amounts of starting materials to achieve a desired composition. The starting materials are then preferably wet-mixed in a bead mill using water and zirconia balls. After mixing/milling, the mixture is dried and then calcined at about 1100° C. for six hours. The calcined mass is then wet pulverized in a bead mill using water and zirconia balls. The calcined material is then dried to obtain a powder.

The additive component is preferably formed by weighing appropriate amounts of starting materials to achieve a desired composition. The starting materials are then preferably wet-mixed in a bead mill using water and zirconia balls. After mixing/milling, the mixture is dried and then calcined at about 750° C. for 3 hours. The resulting glass is converted to frit using water or chilled rollers. The frit is then preferably wet pulverized in a bead mill using water and zirconia balls. The glass is then dried to obtain a powder.

The composition according to the invention is formed by wet-mixing appropriate amounts of the main component and additive component in a bead mill using water and zirconia balls. After drying, an organic binder material such as, for example, an organic binder material such as, for example, polyvinylbutyral, is added to create a ceramic slip. The slip can be cast into any desired form, but is conventionally cast into a green (i.e., unfired) dielectric tape. Internal metal electrode layers are typically screen printed onto the green dielectric tapes. The tapes are then stacked, pressed to form a laminate, and diced. The laminate is then sintered to the minimum temperature necessary to obtain satisfactory densification of the dielectric ceramic. The composition according to the present invention can be sintered in air at a temperature of about 1025° C. or lower, and most preferably within the range of from about 1010° C. to about 1040° C.

The relatively low sintering temperature of the composition facilitates the formation of internal electrode layers using mixtures or alloys of silver and palladium that are substantially lower than typically seen in the art. It is possible, for example, to formulate internal electrode layers using a mixture or alloy containing 90% silver and only 10% palladium by weight. Silver/palladium contents in the range of from about 90/10 to about 85/15 are preferred.

The following examples are intended only to illustrate the invention and should not be construed as imposing limitations upon the claims.

### EXAMPLE 1

Amounts of BaCO₃, CaCO₃, SrCO₃, Nd₂O₃, Gd₂O₃, TiO₂, and SiO₂ sufficient to provide a calcined composition containing, by weight, the equivalent of 17.46% BaO, 1.38% CaO, 1.02% SrO, 23.94% Nd₂O₃, 15.64% Gd₂O₃, 39.39% TiO₂, and 1.16% SiO₂, were weighed and combined. These starting materials were wet-mixed using water and 1 mm zirconia balls in a bead mill until an average particle size of 0.6 μm was obtained. After mixing, the mass was dried and then calcined at a temperature of about 1100° C. for 6 hours. The calcined mass was then wet-pulverized using water and 1 mm zirconia balls in a bead mill and then dried to obtain a calcined main component.

### EXAMPLE 2

Amounts of BaCO₃, ZnO, B₂O₃, and SiO₂ sufficient to provide an additive glass containing, by weight, the equivalent of 52.6% BaO, about 23.2% ZnO, about 17.9% B₂O₃, and about 6.3% SiO₂, were weighed and combined. These starting materials were wet-mixed using water and 2 mm zirconia balls in a bead mill for 16 hours until an average particle size of 0.6 μm was obtained. After mixing, the mass was dried and then calcined at a temperature of about 750° C. for 3 hours. The calcined mass was then wet-pulverized using water in a high speed mixer to obtain an additive glass.

### EXAMPLE 3

Dielectric Compositions A, B, and C were formed by mixing various amounts of the main component from Example 1 and the additive glass from Example 2 as shown in Table 1 below. The powders were wet milled in a bead mill filled with 1 mm zirconia balls for 16 hours until an average particle size of 0.6 μm was obtained. The milled material was dried, and then 1% (by weight) of an organic binder consisting of glycerol was added to the mixed powders to effect granulation. Disc-shaped samples were formed from each composition using a press molding machine. Each disc-shaped sample had a diameter of about 10 mm and a thickness about 0.6 mm. The disc-shaped samples were sintered until they reached 99.5% of theoretical density (the procedure used to determe this temperature is described in Example 5). The disc-shaped samples were held at the top sintering temperature for 1 hour. After sintering, a silver paste (Demetron 61009123) was coated on both surfaces of the ceramic discs and the discs were baked in air at 750° C. Table 1 shows the composition of the sintered discs, the temperature value at which 99.5% of the theoretical density was reached, and the relative dielectric constant.

TABLE 1

| | | | Temperature | Final | Relative |
|---|---|---|---|---|---|
| Dielectric | Main | Ad- | to 99.5% | Density | Dielectric |
| Composition | Component | ditive | Density | (g/cm³) | Constant |
| A | 100 g. | 0 g. | 1180° C. | 5.64 | 80 |
| B | 100 g. | 2 g. | 1055° C. | 5.60 | 76 |
| C | 100 g. | 6 g. | 1030° C. | 5.55 | 70 |

### EXAMPLE 4

A ceramic slip having the same composition as Dielectric Composition C from Example 3 was subjected to sheet molding to obtain green foils having a thickness of about 26 μm. Next, a conductive paste comprising a mixture of 90% by weight silver and 10% by weight palladium was printed on the ceramic green foils. The green foils were cut and then stacked on each other to form a laminate consisting of alternating layers of green foil and conductive paste. There were a total of 15 dielectric layers in the laminate. The laminate was sintered in air at 1000° C. for four hours. After sintering, the thickness of each dielectric layer interposed between each electrode layer was about 20 μm. A silver electrode paste (Demetron 61009123) was coated on opposing surfaces of the sintered laminate and baked in air at a temperature of about 750° C. for 1 hour to form an external electrode that was electrically connected to the internal electrodes. The dielectric ceramic composition satisfied the NPO characteristics upon sintering at a temperature of 1000° C. for 4 hours (i.e., the dielectric ceramic exhibited a relative dielectric constant of 75 or more, a dissipation factor of 0.01%, and a temperature change ratio of electrostatic capacity of 30 ppm/° C. or less.

### EXAMPLE 5

To determine the temperature at which Dielectric Compositions A, B, and C reached 99.5% of theoretical density, dummy sheets were formed and sintered at different temperatures for two hours. The external dimensions of the dummy sheets were 8 mm long, 5 mm wide, and 0.4 mm thick. After sintering, the specific gravity of each dummy was measured using the Archimedes method. The results for Dielectric Composition C is shown in Table 2 below.

TABLE 2

| Sintering | Specific Density |
|---|---|
| Temperature (° C.) | (g/cm³) |
| 976 | 5.206 |
| 979 | 5.231 |
| 989 | 5.370 |
| 991 | 5.438 |
| 997 | 5.461 |
| 1006 | 5.527 |
| 1012 | 5.544 |
| 1017 | 5.551 |
| 1022 | 5.540 |
| 1030 | 5.567 |
| 1033 | 5.548 |
| 1035 | 5.576 |
| 1040 | 5.569 |
| 1043 | 5.568 |
| 1046 | 5.604 |
| 1049 | 5.553 |
| 1051 | 5.555 |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed:

1. A composition for use in forming a sintered NPO dielectric ceramic, said composition comprising a mixture of:
from about 90% to about 99.5% by weight of a calcined main component comprising (Ba, Ca, Sr, Nd, Gd)TiO₃; and
from about 0.5% to about 10% by weight of an additive component comprising a glass, said glass comprising by weight from about 45% to about 54% BaO, from about 19% to about 24% ZnO, from about 13% to about 20% B₂O₃, and from about 2% to about 23% SiO₂.

2. The composition according to claim 1 wherein said calcined main component consists essentially of (Ba, Ca, Sr, Nd, Gd)TiO₃ and from about 0.5% to about 2.0% by weight SiO₂.

3. The composition according to claims 1 or 2 wherein said main component and said additive component both comprise dry powders.

4. The composition according to claim 3 further comprising an organic binder.

5. The composition according to claim 2 wherein said calcined main component is formed by calcining starting materials providing by weight from about 15% to about 19% BaO, from about 0.8% to about 1.7% CaO, from about 0.8% to about 1.3% SrO, from about 12% to about 17% Nd₂O₃, and from about 13% to about 29% Gd₂O₃, from about 38% to about 42% TiO₂, and from about 0.5% to about 2% SiO₂.

6. The composition according to claim 5 wherein said starting materials provide by weight about 17.46% BaO, about 1.38% CaO, about 1.02% SrO, about 23.94% Nd₂O₃, about 15.64% Gd₂O₃, about 39.39% TiO₂, and about 1.16% SiO₂.

7. The composition according to claim 5 wherein said starting materials comprise carbonates and/or oxides.

8. The composition according to claims 1 to 7 wherein said glass comprises by weight about 52.6% BaO, about 23.2% ZnO, about 17.9% B₂O₃, and about 6.3% SiO₂.

9. A method of forming a sintered dielectric ceramic comprising providing a composition according to claims 1 to 8, molding said composition into a desired shape, and sintering said composition at a temperature of about 1025° C. or less.

10. A co-fired multilayer ceramic capacitor comprising a stack of alternating internal metal electrode layers and dielectric ceramic layers, wherein said internal metal electrode layers are formed from a mixture of silver and from about 10% to about 20% by weight palladium and said dielectric ceramic layers are formed from a composition according to claims 1 to 8.
